(19) United States
(12) Patent Application Publication
(10) Pub. No.: US 2018/0287310 A1
(43) Pub. Date: Oct. 4, 2018

(54) CARD EDGE CONNECTOR WITH HOLES FOR TRANSFERRING LIGHT

(71) Applicant: FOXCONN INTERCONNECT TECHNOLOGY LIMITED, Grand Cayman (KY)

(72) Inventors: JUN FANG, Kunshan (CN); XIAO-HU YIN, Kunshan (CN); KUO-CHUN HSU, New Taipei (TW)

(21) Appl. No.: 15/937,834

(22) Filed: Mar. 27, 2018

(30) Foreign Application Priority Data
Mar. 29, 2017 (CN) 201710197603.9

(51) Int. Cl. H01R 13/717; H01R 12/73; H01R 13/6581

(52) U.S. Cl. CPC H01R 13/7175; H01R 13/635; H01R 13/6581; H01R 12/737

(57) ABSTRACT

A card edge connector includes a longitudinal insulative housing, a number of terminals retained in the insulative housing, a pair of transparent members mounted to the insulative housing, and a metallic shell surrounding around the insulative housing. The insulative housing has two side walls extending along a longitudinal direction, two end walls connecting between the longitudinal ends of the two side walls and a center slot defined therebetween. The metallic shell includes two covering portions respectively located above the two side walls in a vertical direction perpendicular to the longitudinal direction. Each of the covering portions has a number of through-holes arranged above the transparent members to leak out the light transferred therefrom.

### FIELD OF THE DISCLOSURE

The invention is related to a card edge connector, and particularly to a card edge connector with a lot of holes for transferring light.

### DESCRIPTION OF RELATED ARTS

Currently, a card edge connector is used to connect a card module card to a printed circuit board. The card edge connector includes an insulative housing, a plurality of terminals retained in the insulative housing and an ejector pivotally mounted to the insulative housing. The insulative housing includes two side walls, a center slot located between the two side walls and a tower-shaped portion protruding upwardly from the side walls. However, the demand of the appearance and the light effect of the card edge connector gradually becomes apparent in the market as the development of the connectors.

Therefore, it is desired to provide a new card edge connector.

### SUMMARY OF THE DISCLOSURE

To achieve the above desire, a card edge connector includes a longitudinal insulative housing having two side walls extending along a longitudinal direction, two end walls extending along a transverse direction and connecting between the longitudinal ends of the two side walls and a center slot defined therebetween; a plurality of terminals retained in the said walls, respectively; a pair of transparent members fixed to the said walls, respectively; a metallic shell surrounding around the insulative housing. The metallic shell comprises two covering portions respectively located above the two side walls in a vertical direction perpendicular to both of the longitudinal direction and the transverse direction. Each of the covering portions comprises a plurality of through-holes arranged along the longitudinal direction and located above the transparent members to leak out the light transferred therefrom.

### BRIEF DESCRIPTION OF THE DRAWINGS

FIG. 1 is a perspective view of a card edge connector according to a first embodiment of the present invention;

FIG. 2 is another perspective view of FIG. 1;

FIG. 3 is an exploded perspective view of the card edge connector of FIG. 1;

FIG. 4 is a cross-sectional view of the card edge connector of FIG. 1 taken along line 4-4 thereof;

FIG. 5 is a cross-sectional view of the card edge connector of FIG. 1 taken along line 5-5 thereof;

FIG. 6 is an exploded perspective view of a card edge connector according to a second embodiment of the present invention;

FIG. 7 is a cross-sectional view of the card edge connector of FIG. 6;

FIG. 8 is a perspective view of a metallic shell according to a third embodiment of the present invention;

FIG. 9 is a perspective view of a metallic shell according to a fourth embodiment of the present invention;

FIG. 10 is a perspective view of a card edge connector according to a fifth embodiment of the present invention;

FIG. 11 is an exploded perspective view of the card edge connector of FIG. 10;

FIG. 12 is another exploded perspective view of FIG. 11;

FIG. 13 is a cross-sectional view of the card edge connector of FIG. 10 taken along line 13-13 thereof;

FIG. 14 is an exploded perspective view of a card edge connector according to a sixth embodiment of the present invention;

FIG. 15 is an perspective view of a card edge connector according to a seventh embodiment of the present invention;

FIG. 16 is an exploded perspective view of the card edge connector of FIG. 15; and

FIG. 17 is a cross-sectional view of the card edge connector of FIG. 15 taken along line 17-17 thereof.

### DETAILED DESCRIPTION OF THE PREFERRED EMBODIMENT

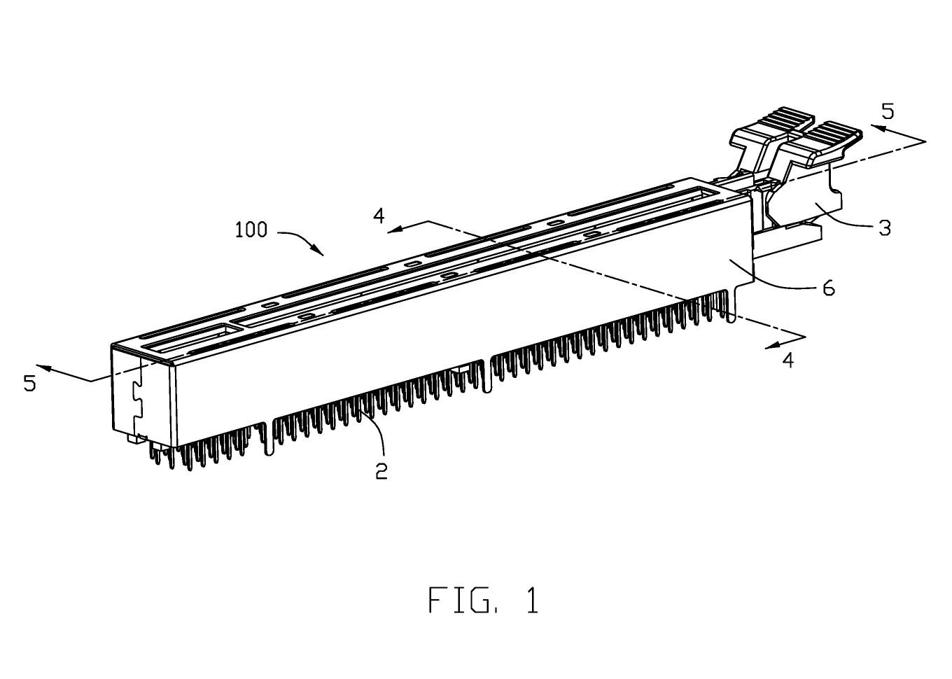

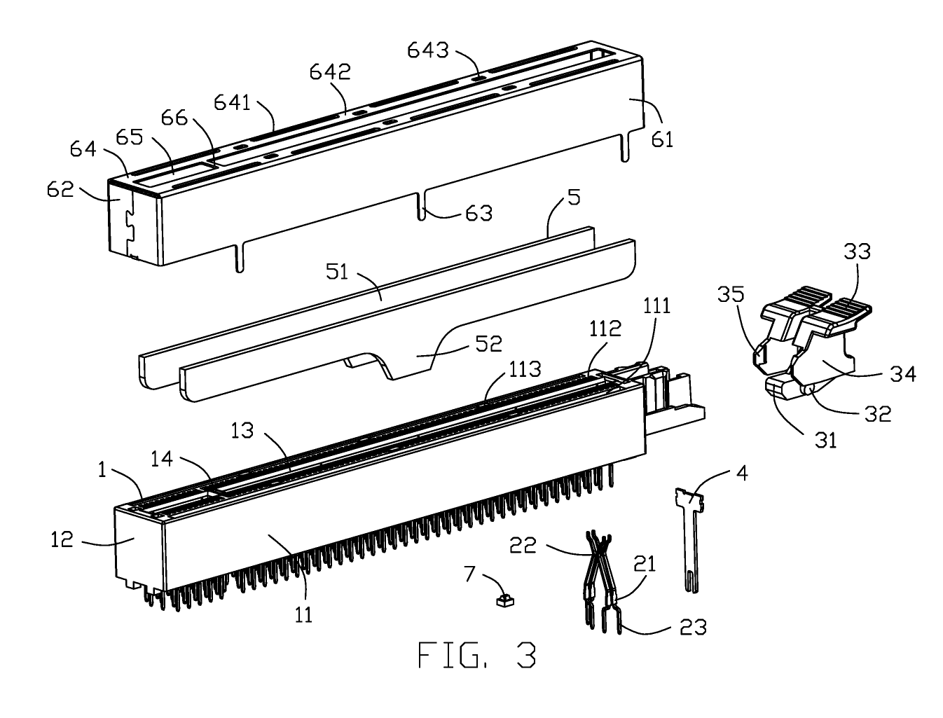

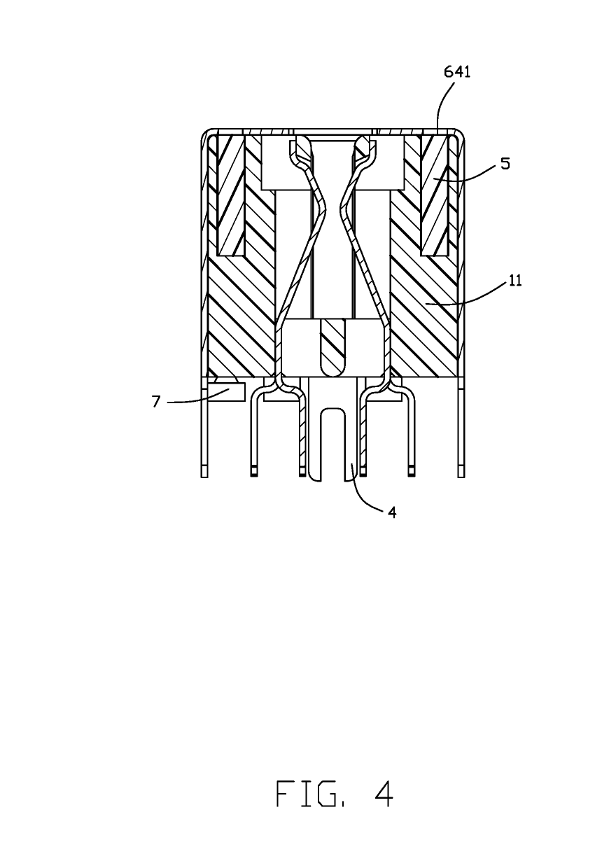

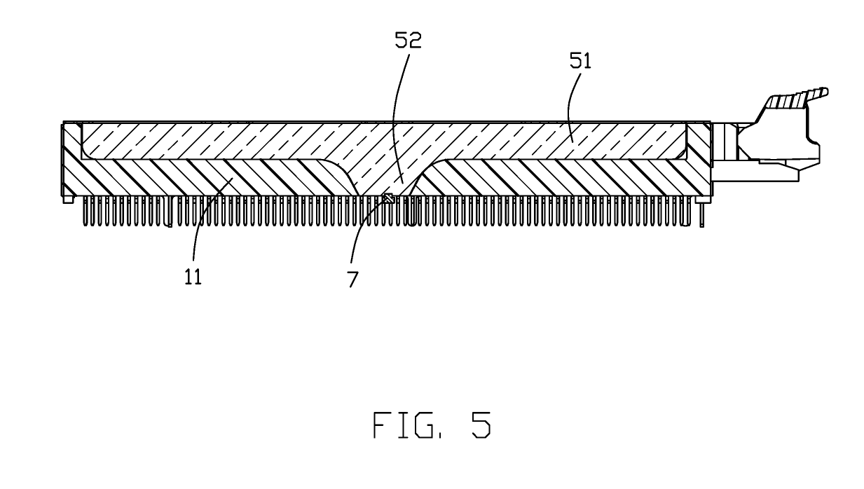

Reference will now be made in detail to the embodiments of the present disclosure. Referring to FIGS. 1-5, a card edge connector 100 is used to electrically connect a card module (not shown) with a mother board (not shown). The card edge connector 100 includes a longitudinal insulative housing 1, a plurality of terminals 2 retained in the insulative housing 1, an ejector 3 pivotally mounted to an end of the insulative housing 1, a pair of metallic members 4 retained in the insulative housing 1, a pair of transparent/translucent members or light guide pieces 5 mounted to the insulative housing 1, a metallic shell 6 surrounding around the insulative housing 1, and a LED (Light Emitting Diode) 7 fixed to a bottom side of the insulative housing 1.

The insulative housing 1 includes two side walls 11 extending along a longitudinal direction, two end walls 12 connecting between the longitudinal ends of the two side walls 11, and a center slot 13 defined therebetween. The card module (not shown) is inserted into the center slot 13 to electrically connect with the terminals 2. Each of the side walls 11 includes a plurality of terminal slots 112 communicating with the center slot 13. The terminal slots 112 go through two top surfaces of the two side walls 11 along a vertical direction, respectively. Each of the side walls 11 includes a groove 111 for receiving the transparent member 5. Each of the grooves 111 goes through the top surface of the side wall 11 so that the transparent member 5 would be exposed to the top surface of the side wall 11. Each of the side walls 11 includes a plurality of first positioning portions 113 protruding upwardly from the top surface of the side wall 11. The first positioning portions 113 are located between the terminal slots 112 and the grooves 111 in a transverse direction perpendicular to the longitudinal direction.

The plurality of terminals 2 are retained in the terminal slots 112, respectively. Each of the terminals 2 includes a retaining section 21 retained in the insulative housing 1, a contacting section 22 extending upwardly from the retaining section 21 into the center slot 13, and a soldering section 23 extending downwardly from the retaining section 21 and beyond the insulative housing 1.

The ejector 3 includes a base portion 31, two shafting portions 32 protruding from two corresponding opposite sides of the base portion 31, two supporting portions 34 extending upwardly from the base portion 31, two operating portions 33 extending outwardly from a top side of the supporting portions 34, respectively. The ejector 3 includes two hooks 35 respectively extending from the supporting portions 34 to the center slot 13 for hooking with the insulative housing 1.

Each of the transparent members 5 includes a longitudinal main portion 51 and an extending portion 52 extending downwardly therefrom. The length of the extending portion 52 is shorter than the length of the main portion 51 in the longitudinal direction so that the transparent members 5 would be easily mounted into the grooves 111. Each of the extending portions 52 is exposed to a bottom surface of the side walls 11, respectively.

The metallic shell 6 includes two long walls 61 respectively covering the two side walls 11, two short walls 62 connecting therebetween, a plurality of soldering pins 63 extending downwardly from a bottom side of the long walls 61, and two covering portions 64 located above the top surfaces of the two side walls 11 in the vertical direction, respectively. Each of the covering portions 64 extends from a top side of one side wall 11 to the center slot 13. The metallic shell 6 includes a longitudinal gap 65 between the two covering portions 64. The gap 65 is aligned to the center slot 13. The insulative housing 1 has an interval portion 14 located between the two side walls 11. The metallic shell 6 includes a connecting portion 66 connecting between the two covering portions 64. The connecting portion 66 covers on the interval portion 14. Each of the covering portions 64 includes a plurality of through-holes 641 spaced from each other along the longitudinal direction, a plurality of blocking portions 642 located between the through-holes 641, and a plurality of second positioning portions 643 located between the blocking portions 642 and the gap 65 in the transverse direction. The through-holes 641 are a plurality of long strip holes respectively located above the two transparent members 5 to leak out the light transferred from the LED 7 through the transparent members 5. The second positioning portions 643 going through the covering portion 64 for cooperating with the first positioning portions 113 so that the metallic shell 6 would be retained to the insulative housing 1.

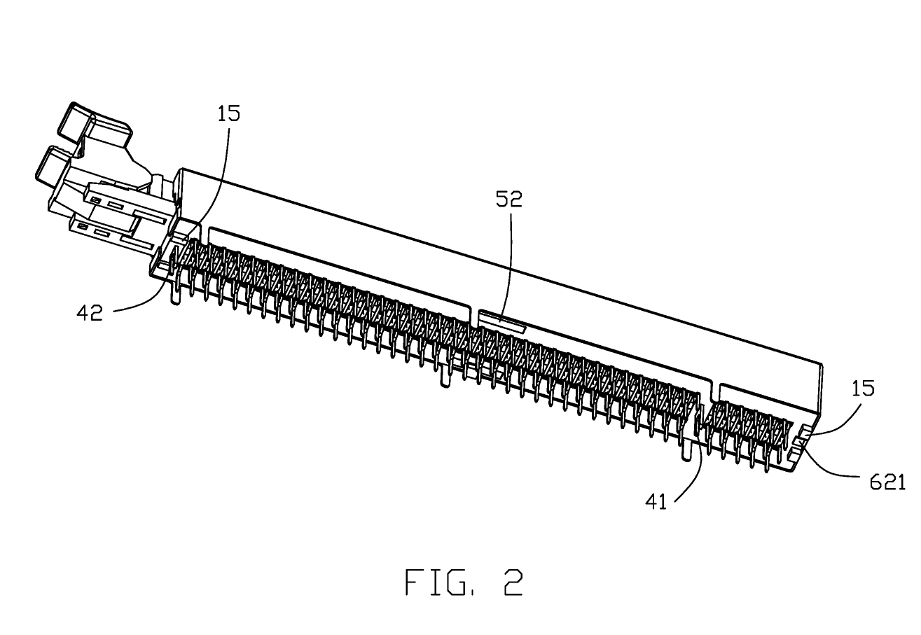

Referring to FIG. 2, each of the short walls 62 has a holding pin 621 extending downwardly from a bottom side of the short wall 62. The holding pins 621 would be bended to be retained to a bottom surface of the insulative housing 1 to avoid the metallic shell 6 shaking. The insulative housing 1 has a lot of bumps 15 protruding downwardly from the bottom surface of the insulative housing 1 to reduce the manufacturing errors. The metallic members 4 includes a first member 41 located below the interval portion 14 and a second member 42 located below the end of the insulative housing 1 near to the ejector 3.

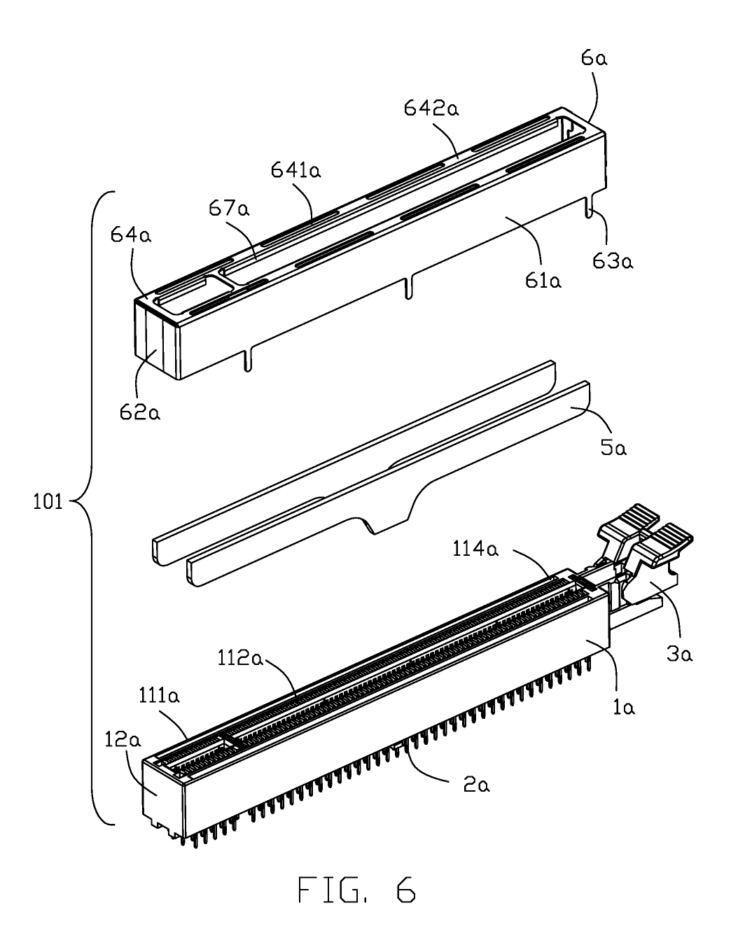

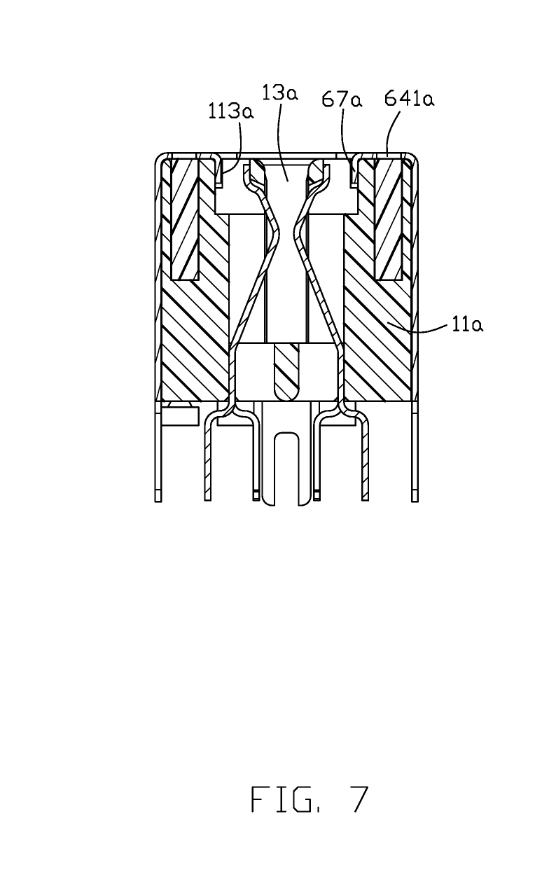

Reference will now be made in detail to a second embodiment of the present disclosure. Referring to FIGS. 6 and 7, a card edge connector 101 includes a longitudinal insulative housing 1a, a plurality of terminals 2a retained in the insulative housing 1a, an ejector 3a pivotally mounted to an end of the insulative housing 1a, a pair of transparent members 5a mounted to the insulative housing 1a, and a metallic shell 6a surrounding around the insulative housing 1a. The terminals 2a, the ejector 3a, and the transparent members 5a will not be described in detail because they are similar to the card edge connector 100 of the first embodiment.

The insulative housing 1a includes two side walls 11a extending along the longitudinal direction, two end walls 12a connecting between the longitudinal ends of the two side walls 11a and a center slot 13a defined therebetween. Each of the side walls 11a includes a plurality of terminal slots 112a communicating with the center slot 13a, a groove 111a for receiving the transparent member 5a, and a mounting slot 113a located between the groove 111a and the terminal slot 112a in a transverse direction. The grooves 111a go through the two top surfaces of the two side walls 11a so that the transparent members 5a would be exposed to the top surfaces of the side walls 11a, respectively. The mounting slot 113a communicates with the terminal slot 112a.

The metallic shell 6a includes two long walls 61a respectively covering the two side walls 11a, two short walls 62a connecting therebetween, a plurality of soldering pins 63a extending downwardly from a bottom side of the long walls 61a, and two covering portions 64a located above the two side walls 11a in the vertical direction, respectively. Each of the covering portions 64a extends from the top side of one side wall 11a to the center slot 13a. The metallic shell 6a further includes a pair of holding portions 67a respectively extending from the covering portions 64a to the center slot 13a. The holding portions 67a are bended downwardly into the mounting slot 113a to avoid the metallic shell 6a shaking. Each of the covering portions 64a includes a plurality of through-holes 641a arranged in a regular intervals manner along the longitudinal direction and a plurality of blocking portions 642a located between the through-holes 641a. The through-holes 641a are a plurality of long strip holes respectively located above the two transparent members 5a to leak out the light transferred therefrom.

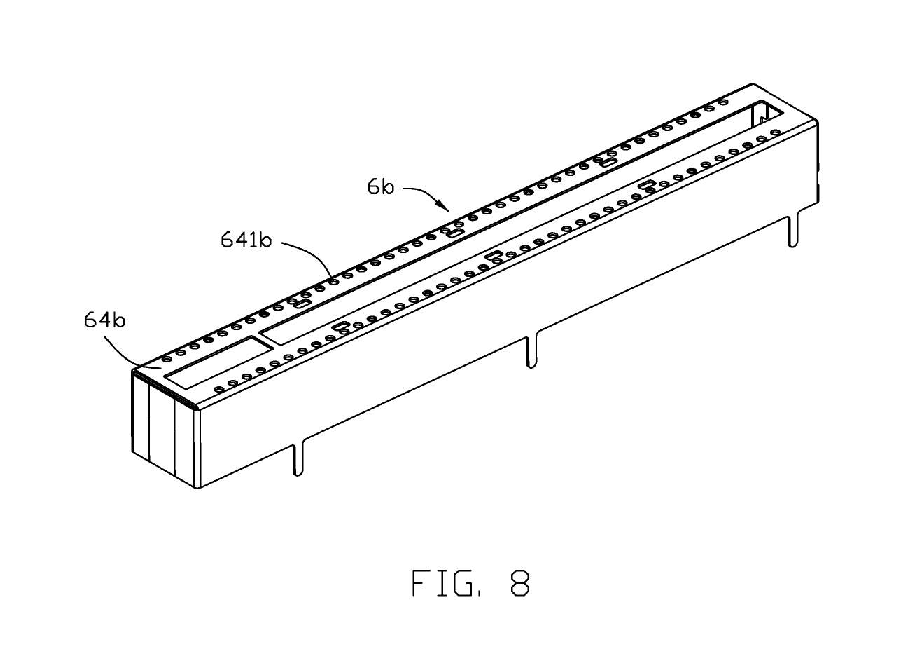

FIG. 8 shows a card edge connector according to a third embodiment of the present invention. Compared to the metallic shell 6 of the card edge connector 100 of the first embodiment, the metallic shell 6b of the third embodiment only changes the structure of the through-holes 641b from the long strip shape to the interval circular holes to emit different light from the LED 7.

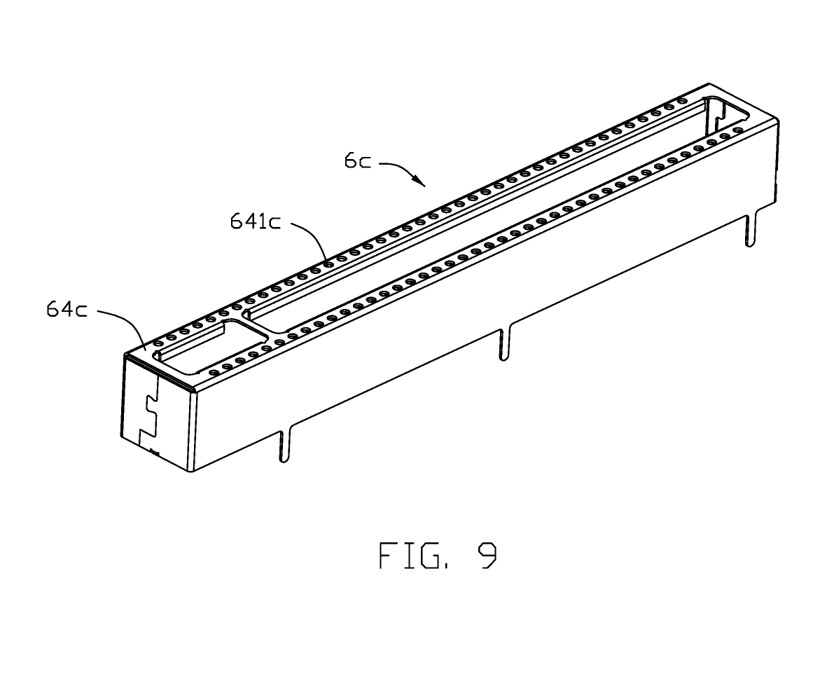

FIG. 9 shows a card edge connector according to a fourth embodiment of the present invention. Compared to the metallic shell 6a of the card edge connector 101, the metallic shell 6c of the fourth embodiment only changes the structure of the through-holes 641c from the long strip shape to the interval circular holes to emit different light from the LED 7.

The transparent members of the card edge connectors of the first, second and third embodiments are loaded downwardly into the insulative housing in the vertical direction.

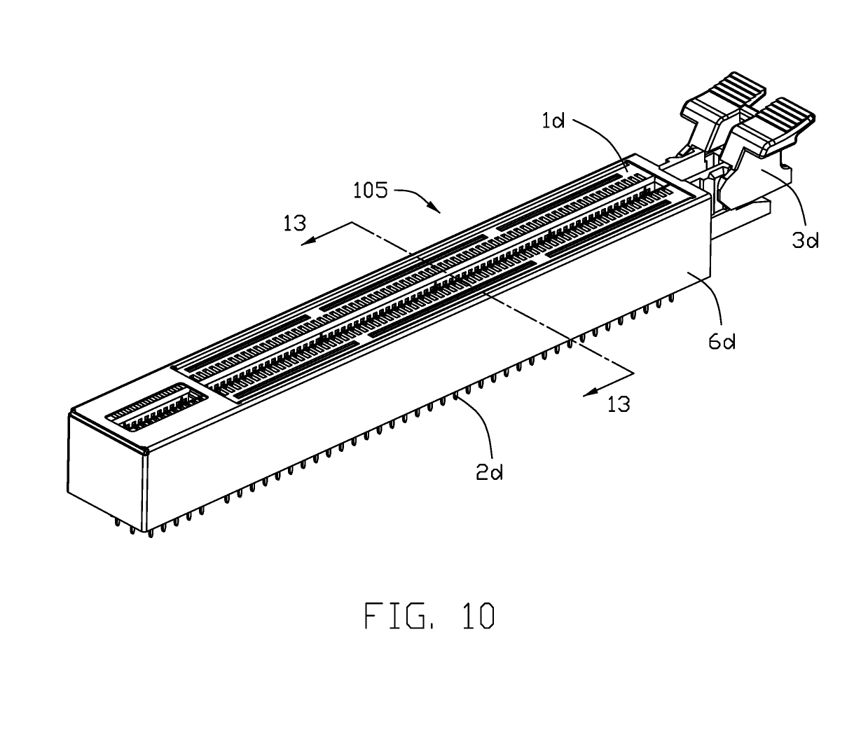

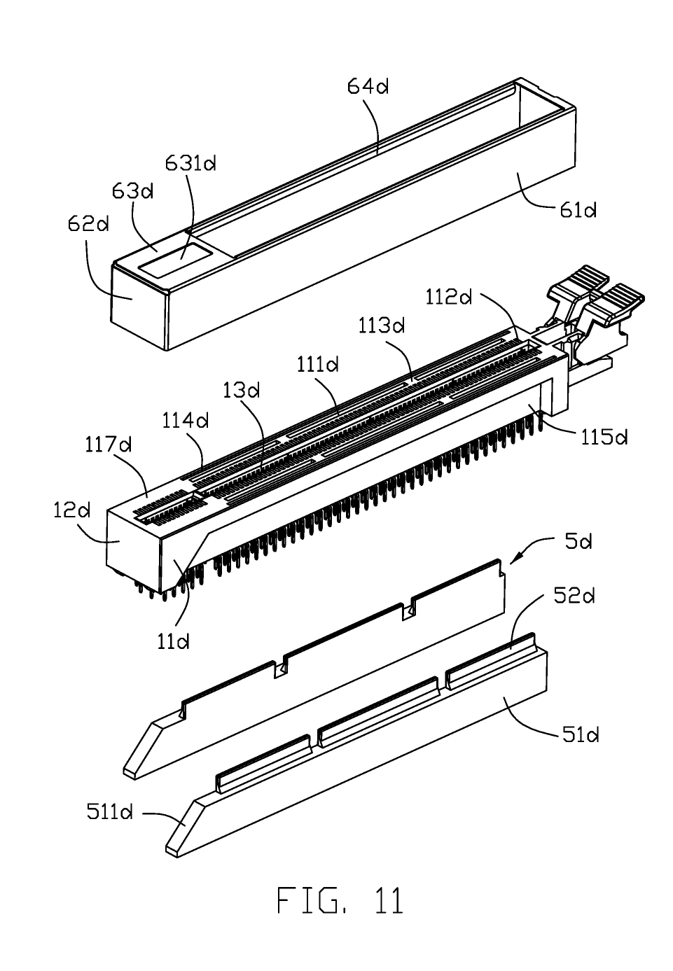

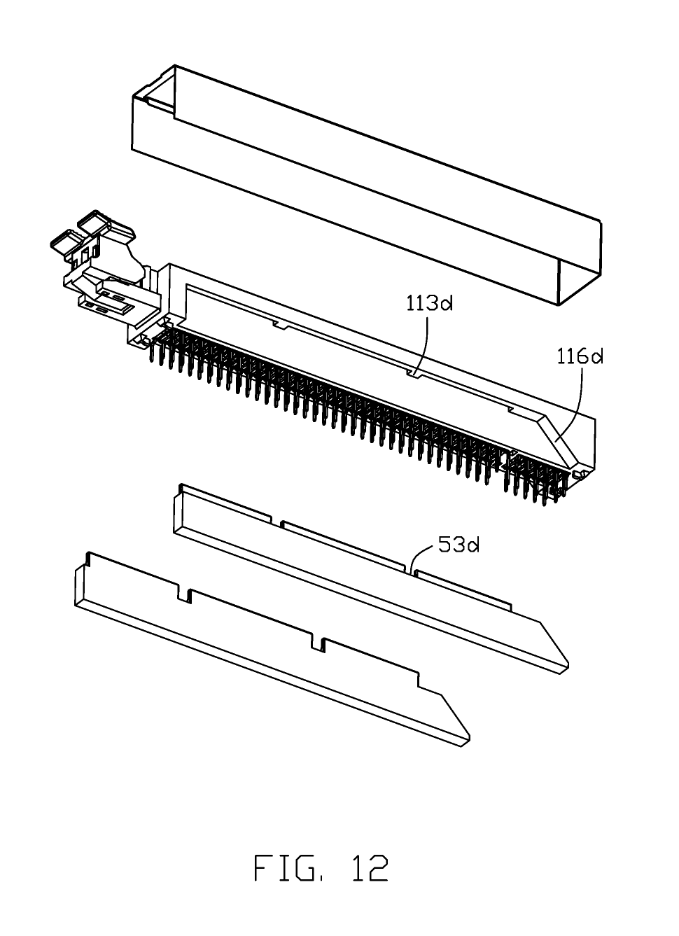

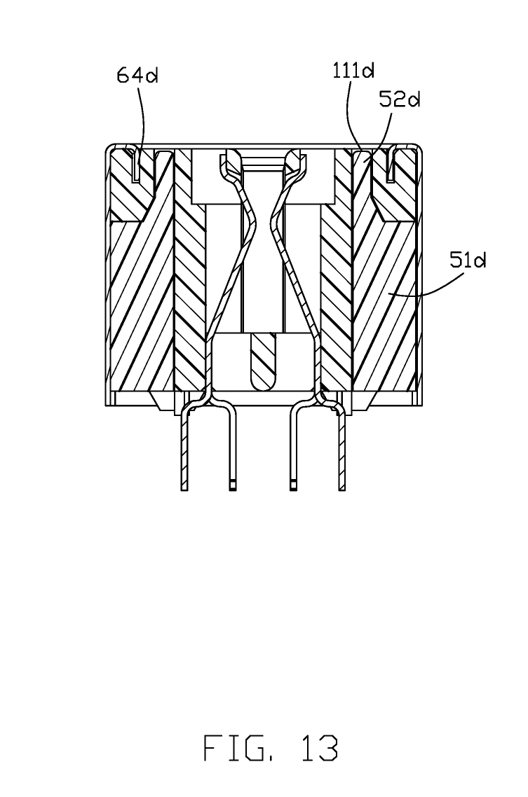

Reference will now be made in detail to a fifth embodiment of the present disclosure. Referring to FIGS. 10 to 13, a card edge connector 105 includes a longitudinal insulative housing 1d, a plurality of terminals 2d retained in the insulative housing 1d, an ejector 3d pivotally mounted to an end of the insulative housing 1d, a pair of transparent members 5d mounted to the insulative housing 1d, and a metallic shell 6d surrounding around the insulative housing 1d.

The insulative housing 1d includes two side walls 11d extending along the longitudinal direction, two end walls 12d connecting between the longitudinal ends of the two side walls 11d and a center slot 13d defined therebetween. Each of the side walls 11d includes a plurality of terminal slots 112d communicating with the center slot 13d, a plurality of through-holes 111d going through the two top surfaces of the two side walls 11d, a plurality of blocking portions 113d located between the through-holes 111d, and a pair of mounting slots 114d respectively going through the top surfaces of the side walls 11d. The through-holes 111d are a plurality of long strip holes arranged in a regular intervals manner along the longitudinal direction. The through-holes 111d of one side wall 11d are located between the terminal slots 112d and the mounting slot 114d in the transverse direction, respectively.

The insulative housing 1d includes a pair of grooves 115d going through two side faces of the side walls 11d, respectively. The through-holes 111d communicate with the grooves 115d. Each of the transparent members 5d includes a main portion 51d received in the groove 115d, a plurality of extending portions 52d extending upwardly from the main portion 51d, a plurality of notches 53d located between the extending portions 52d. The extending portions 52d are received in the corresponding through-holes 111d to be exposed to the top surface of the side wall 11d, while the blocking portions 113d are received in the corresponding notches 53d. The transparent member 5d includes a pair of inclined faces connecting between the main portion 51d and the extending portions 52d to prevent the right-angle structure from being broken easily. The main portion 51d includes a lead-in portion 511d at a longitudinal end thereof, while the insulative housing 1d has a corresponding lead-in surface 116d. A semi-closed structure 117d is provided at an end of the insulative housing 1d located corresponding to the lead-in surface 116d.

The metallic shell 6d includes two long walls 61d respectively covering the two side walls 11d and two short walls 62d connecting therebetween. The metallic shell 6d has a shrouding portion 63d covering on the semi-closed structure 117d of the insulative housing 1d. The shrouding portion 63d has a through slot 631d corresponding to the center slot 13. The metallic shell 6d further includes a pair of holding portions 64d extending from a top side of the long wall 61d to the center slot 13d. The holding portions 64d are bended downwardly into the mounting slot 114d to avoid the metallic shell 6d shaking.

In this embodiment, the LED 7 is mounted at a bottom surface of the insulative housing 1d corresponding to the semi-closed structure 117d. Therefore, the semi-closed structure 117d and the shrouding portion 63d would block the light from the LED 7. Then the light could be transferred to the extending portions 52d by the lead-in portion 511d.

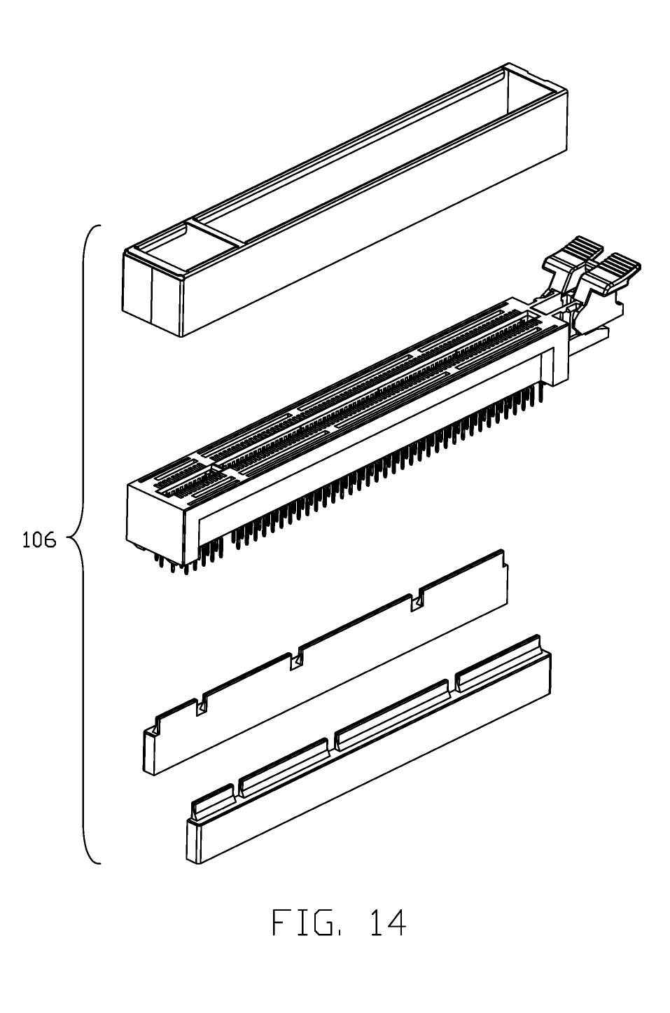

FIG. 14 shows a card edge connector 106 according to a sixth embodiment of the present invention. Compared to the fifth embodiment above, the shrouding portion 63d, the semi-closed structure 117d and the lead-in portion 511d are all removed because the LED 7 is mounted at the middle bottom of the insulative housing.

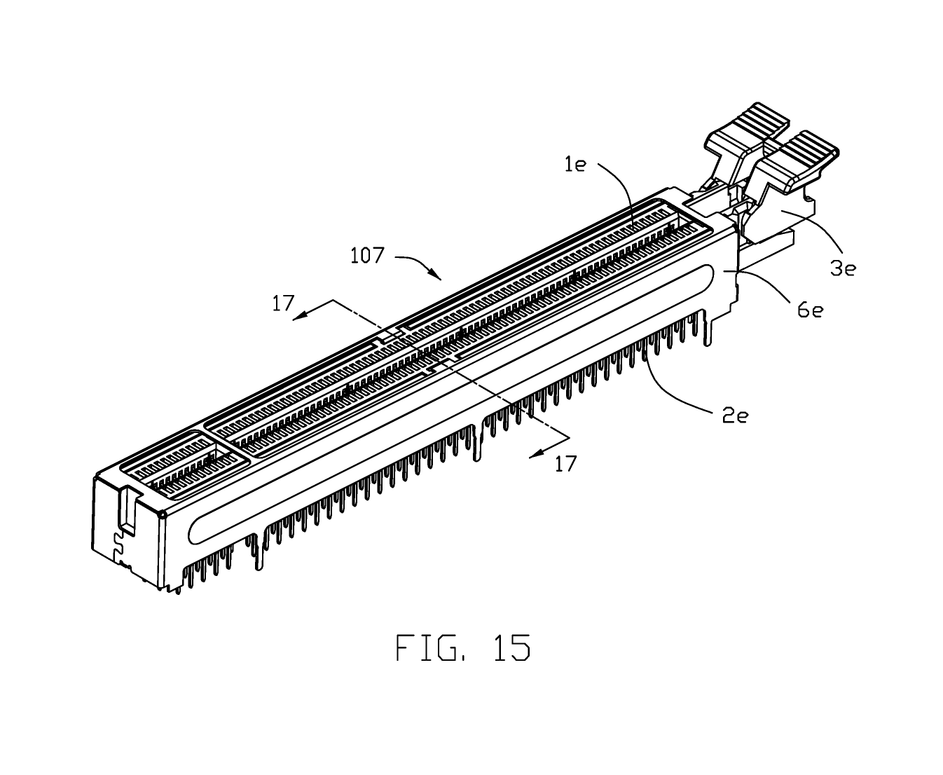

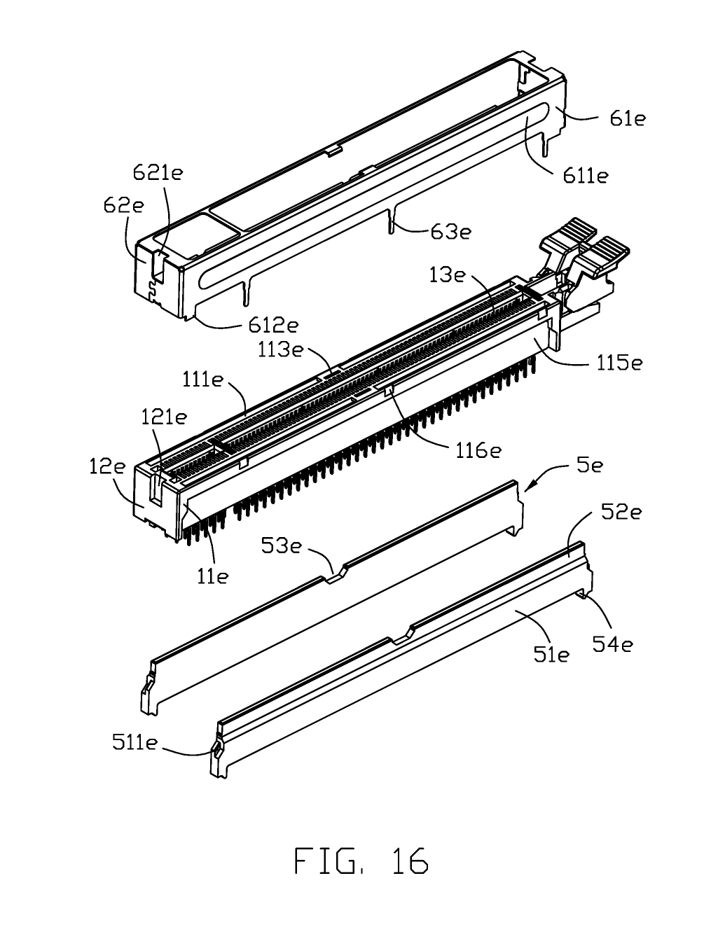

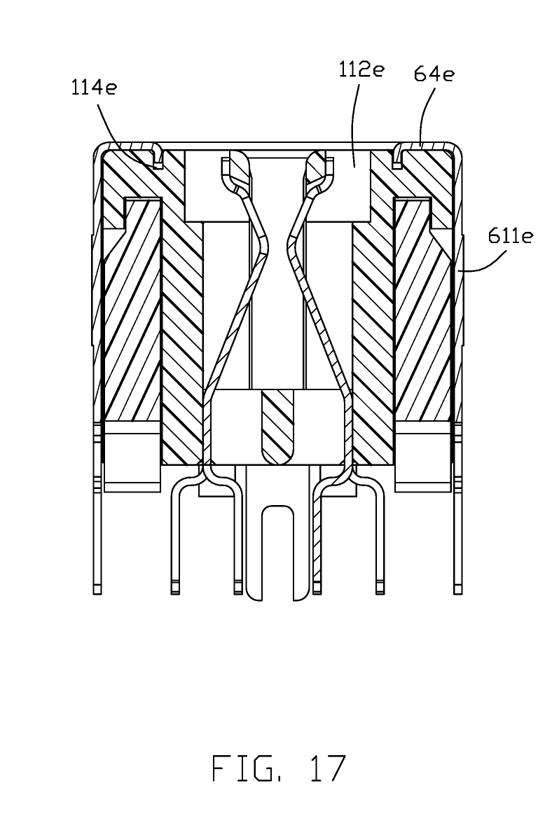

Reference will now be made in detail to a seventh embodiment of the present disclosure. Referring to FIGS. 15 to 17, a card edge connector 107 includes a longitudinal insulative housing 1e, a plurality of terminals 2e retained in the insulative housing 1e, an ejector 3e pivotally mounted to an end of the insulative housing 1e, a pair of transparent members 5e mounted to the insulative housing 1e, and a metallic shell 6e surrounding around the insulative housing 1e.

The insulative housing 1e includes two side walls 11e extending along the longitudinal direction, two end walls 12e connecting between the longitudinal ends of the two side walls 11e and a center slot 13e defined therebetween. Each of the side walls 11e includes a plurality of terminal slots 112e connecting with the center slot 13e, a pair of through-holes 111e respectively going through the two top surfaces of the two side walls 11e, and a pair of blocking portions 113e respectively located at the middle of the through-holes 111e to divided the through-hole 111e into two parts. The blocking portion has a mounting slot 114e going through a top surface thereof. The depth of the mounting slot 114e is smaller than the depth of the through-hole 111e in the vertical direction. The insulative housing 1e includes a pair of grooves 115e going through two side faces of the side walls 11e, respectively. One of the end walls 12e has a breach 121e going through a side face thereof.

Each of the transparent members 5e includes a main portion 51e received in the groove 115e, an extending portion 52e extending upwardly from a top side of the main portion 51e, and a notch 53e located at the middle of extending portion 51e to divided the extending portion 52e into two parts corresponding to the through-hole 111e. The extending portion 52e is received in the through-hole 111e and exposed to the top surface of the side wall 11e. The transparent member 5e includes a pair of inclined faces connecting between the main portion 51e and the extending portion 52e to prevent the right-angle structure from being broken easily. The main portion 51e includes a pair of ribs 511e located at the two longitudinal ends thereof, while the insulative housing 1e includes two corresponding notches. When the transparent members 5e are inserted in the grooves 115e, the ribs 511e are inserted in the notches for mounting the transparent members 5e to the insulative housing 1e tightly. Then, the blocking portions 113e are received in the notches 53e. Each of the transparent members 5e has two pins 54e located at two ends of the main portion 51e.

The metallic shell 6e includes two long walls 61e respectively covering the two side walls 11e, two short walls 62e connecting therebetween, and a plurality of soldering pins 63e extending downwardly from the long walls 61e. Each of the long walls 61e includes an elongated convex hull 611e protruding outwardly at middle of the long wall 61e and two shrouding parts 612e extending downwardly from two ends of the long wall 61e for covering the two pins 54e. One of the two short walls 62e has an opening 621e corresponding to the breach 12e. The metallic shell 6e includes a pair of holding portions 64e respectively extending from a top side of the two long walls 61e to the center slot 13e. The holding portions 64e are bended into the corresponding mounting slots 114e to prevent the metallic shell 6e from shaking. Each of the side walls 11e includes a plurality of lead-in portions or recesses 116e at the top side of the side wall 11e for guiding the soldering pins 63e during assembling the metallic shell 6e unto the housing 1e, thus avoiding improper deflection of the soldering pines during assembling.

One main feature of the present invention described above provides long strip light transferring/transmitting holes 641, 641a or dense circular light transferring/transmitting holes 641b, 641c in the metallic shell 6, 6a, 6b, 6c, or long strip light transferring/transmitting holes 111d, 111e in the insulative housing 1d, 1e to achieve variety of light effects so that the light may be directly spread out via the transferring holes 111 of the housing 1 if the shell 6 has no corresponding portion covering such areas, or further via the transferring hole 641 of the shell if the shell 6 has corresponding covering portion shielding such areas. Notably, the transferring holes 111 of the housing 1 and the transferring holes 641 of the shell 6 may be of one-to-one relation or one-to-more relation based upon the consideration of manufacturability and strength thereof. In addition, having the housing confine the transparent member is more stable than having the transparent member confined by the metallic shell in a technical viewpoint. In other words, the transparent member 5 is retained to the housing 1 rather than to the metallic shell for reliable fixation. Correspondingly, corresponding parts of the transparent member 5 around the corresponding transferring holes should be sandwiched or held by the housing 1 rather than sidewardly exposed to the metallic shell in the transverse direction. Another feature of the present invention is to have the preformed metallic shell 6 assembled unto the housing 1 instead of insert-molded within the housing for manufacturability consideration. Another feature of the invention is to have the transparent members 5 have the extending portion 52 reaching the bottom of the housing so as to be close to the LED 7 for efficient light transmission.

While a preferred embodiment according to the present disclosure has been shown and described, equivalent modifications and changes known to persons skilled in the art according to the spirit of the present disclosure are considered within the scope of the present disclosure as described in the appended claims.

What is claimed is:

1. A card edge connector comprising:
a longitudinal insulative housing having two side walls extending along a longitudinal direction, two end walls extending along a transverse direction perpendicular to said longitudinal direction and connecting between the longitudinal ends of the two side walls and a center slot defined therebetween;
a plurality of terminals retained in the said walls, respectively;
a pair of transparent members fixed to the said walls, respectively;
a metallic shell surrounding around the insulative housing; wherein
the metallic shell comprises two covering portions respectively located above top surfaces of the two side walls in a vertical direction perpendicular to both of the longitudinal direction and the transverse direction, each of the covering portions comprises a plurality of through-holes arranged along the longitudinal direction and located above the transparent members to leak out the light transmitted therefrom.

2. The card edge connector as claimed in claim 1, wherein each of the side walls comprises a groove going through a top surface of the side wall along the vertical direction, and the transparent members are received in the grooves and exposed to the top surface of the side walls, respectively.

3. The card edge connector as claimed in claim 1, wherein the through-holes are a plurality of circular holes or long strip holes arranged in a regular intervals manner along the longitudinal direction.

4. The card edge connector as claimed in claim 3, wherein each of the side walls comprises a plurality of first positioning portions protruding upwardly from a top surface of the side wall, each of the covering portions comprises a plurality of second positioning portions corresponding to the first positioning portions, and the second positioning portions are located between the through-holes and the center slot in the transverse direction.

5. The card edge connector as claimed in claim 2, wherein each of the transparent members comprises a longitudinal main portion and an extending portion extending downwardly therefrom, and the extending portion is exposed to a bottom surface of the side wall.

6. A card edge connector comprising:
a longitudinal insulative housing having two side walls extending along a longitudinal direction, two end walls connecting between the longitudinal ends of the two side walls and a center slot defined therebetween;
a plurality of terminals retained in the insulative housing;
a pair of transparent members fixed to the insulative housing;
a metallic shell surrounding around the insulative housing; wherein
each of the side walls comprises a plurality of through-holes going through a top surface of the side wall, and the through-holes are arranged along the longitudinal direction and respectively located above the two transparent members to spread out the light transmitted therefrom.

7. The card edge connector as claimed in claim 6, wherein each of the side walls comprises a groove communicating with the through-holes, each of the transparent members comprises a longitudinal main portion received in the groove and a plurality of extending portions extending upwardly therefrom, and the extending portions are received in the through-holes and exposed to the top surface of the side walls.

8. The card edge connector as claimed in claim 7, wherein the through-holes are a plurality of long strip holes arranged in a regular intervals manner along the longitudinal direction, and the extending portions are arranged corresponding to the long strip holes.

9. The card edge connector as claimed in claim 6, wherein the metallic shell comprises two long walls respectively covering the two side walls and two holding portions extending from a top side of the corresponding long walls, and both of the holding portions are bended into the center slot.

10. The card edge connector as claimed in claim 7, wherein the main portion has a lead-in portion, and the metallic shell comprises a shrouding portion covering on an end of the insulative housing corresponding to the lead-in portion.

11. A card edge connector comprising:
an insulative housing defining a pair of opposite side walls each extending along a longitudinal direction, a pair of end walls connected at two longitudinal ends of the pair of side walls, and a center slot formed between said pair of side walls in a transverse direction perpendicular to said longitudinal direction, each of said side walls forming a top surface in a vertical direction perpendicular to both said longitudinal direction and said transverse direction;
a plurality of terminal slots formed in each of said side walls and communicating the the center slot in the transverse direction;
at least one ejector located by one end wall of said housing;
two rows of terminals disposed in the corresponding terminal slots of said side walls, respectively;
a pair of light guide members associated with the corresponding side walls, respectively;
an LED (Light-Emitting Diode) being located under each of said light guide members to transmit light toward the corresponding light guide member; and
a metallic shell attached upon the housing and covering said pair of side walls, wherein
the pair of light guide members are retained in the corresponding side walls, respectively, and each of said side walls forms upward holes to allow light from the corresponding light guide member to be upwardly spread out via said holes.

12. The card edge connector as claimed in claim 11, wherein said shell covers a top surface of each of said side walls, and further defines a plurality of holes aligned with the corresponding holes of the housing in the vertical direction for allow said light to be upwardly spread out.

13. The card edge connector as claimed in claim 11, wherein the metallic shell is preformed to be of a complete configuration and downwardly assembled upon the housing in the vertical direction, and further includes a plurality of downwardly extending soldering pins at a bottom portion thereof.

14. The card edge connector as claimed in claim 13, wherein the housing forms a plurality of recesses aligned with the corresponding soldering pins in the vertical direction, respectively,.

15. The card edge connector as claimed in claim 11, wherein said metallic shell includes a holding portion located on a top surface of each corresponding side wall and downwardly extending into the housing for preventing the shell from moving outwardly and sidewardly in the transverse direction.

16. The card edge connector as claimed in claim 15, wherein said holding portion is located between the upward holes of the corresponding side wall and the center slit in the transverse direction.

17. The card edge connector as claimed in claim 16, wherein said holding portion extends into the corresponding terminal slots.

18. The card edge connector as claimed in claim 15, wherein said holding portion is located outside of both the upward holes and the terminal slots of the corresponding side wall in the transverse direction.

19. The card edge connector as claimed in claim 11, wherein each of said side walls forms a groove to receive the corresponding light guide members therein.

20. The card edge connector as claimed in claim 19, wherein said groove is not outwardly exposed to the metallic shell in the transverse direction.
